(19) United States
(12) Patent Application Publication
(10) Pub. No.: US 2023/0093941 A1
(43) Pub. Date: Mar. 30, 2023

(54) POWDER LAYER COMPOSITE FOR ENERGY DEVICE, METHOD FOR MANUFACTURING SAME, AND POWDER COATING APPARATUS FOR ENERGY DEVICE

(71) Applicant: Panasonic Intellectual Property Management Co., Ltd., Osaka (JP)

(72) Inventors: TOSHIYUKI KOJIMA, Kyoto (JP); AKIHIRO HORIKAWA, Osaka (JP); SHUZO TSUCHIDA, Nara (JP)

(21) Appl. No.: 17/929,752

(22) Filed: Sep. 6, 2022

(30) Foreign Application Priority Data
Sep. 29, 2021 (JP) 2021-159292

(51) Int. Cl. H01M 4/04

(52) U.S. Cl. CPC H01M 4/0409; H01M 2004/021

(57) ABSTRACT

A powder layer composite includes a current collector, and a powder layer formed on the current collector and having a film thickness of 50 μm or more. The powder layer contains a powder made of at least one type of particle material. A concentration of a solvent contained in the powder layer is 50 ppm or less. A variation in a weight per unit area of the powder layer is 10% or less in an optional region with 30 mm×30 mm in the powder layer.

### BACKGROUND

### 1. Technical Field

The present disclosure relates to a powder layer composite for an energy device, a method for manufacturing the same, and a powder coating apparatus for an energy device.

### 2. Description of the Related Art

In the related art, a technique of coating a surface of a member such as a current collector with a powder while conveying the current collector has been known.

For example, Japanese Patent No. 6067636 discloses a technique of coating a surface of a current collector that is a long (large-sized) current collector with a powder composite material containing an active material.

Japanese Patent No. 6067636 discloses that a powder is supplied onto the surface of the current collector, and then the supplied powder is flattened by a squeegee to uniformly adjust a thickness of a layer formed of the powder (hereinafter, referred to as a “powder layer”).

### CITATION LIST

### Patent Literature

PTL 1: Japanese Patent No. 6067636

### SUMMARY

A powder layer composite for an energy device according to an aspect of the present disclosure includes: a current collector; and a powder layer formed on the current collector and having a film thickness of 50 μm or more, in which the powder layer contains a powder made of at least one type of particle material, a concentration of a solvent contained in the powder layer is 50 ppm or less, and a variation in a weight per unit area of the powder layer is 10% or less in an optional region with 30 mm×30 mm in the powder layer.

A method for manufacturing a powder layer composite for an energy device according to an aspect of the present disclosure includes: supplying a powder onto a surface of a current collector to form a powder layer containing the powder; and adjusting a thickness of the powder layer and a filling rate of the powder in the powder layer by using the squeegee vibrated at a frequency of 2 kHz or more and 300 kHz or less, while relatively moving the current collector in a predetermined direction with respect to a squeegee disposed to form a gap with the current collector, in which in the adjusting of the thickness of the powder layer and the filling rate of the powder in the powder layer, the powder in the powder layer is filled such that the filling rate of the powder in the powder layer is equal to or higher than a tap filling rate of the powder.

A powder coating apparatus for an energy device according to an aspect of the present disclosure includes: a powder supply unit configured to supply a powder onto a surface of a current collector; a squeegee disposed to form a gap with the current collector, and configured to be vibrated at a frequency of 2 kHz or more and 300 kHz or less, and to adjust a weight per unit area and a filling rate of the powder supplied onto the surface of the current collector by the powder supply unit; a drive unit configured to relatively move the current collector in a predetermined direction with respect to the squeegee; and a control unit configured to control at least one of the gap and vibration of the squeegee.

### BRIEF DESCRIPTION OF THE DRAWINGS

FIG. 1 is a schematic diagram illustrating a powder layer according to a comparative example;

FIG. 2 is a schematic diagram of a powder layer composite according to an embodiment;

FIG. 3 is a flowchart showing a method for manufacturing the powder layer composite according to the embodiment;

FIG. 4A is a schematic diagram illustrating a step of filling a powder supplied onto a surface of a current collector in a powder alignment step according to the embodiment;

FIG. 4B is a schematic diagram illustrating a state where a surplus powder is ejected onto an upper portion of a powder layer in the powder alignment step according to the embodiment;

FIG. 4C is a schematic diagram illustrating a state where the surplus powder is scraped off and a thickness of the powder layer is made constant in the powder alignment step according to the embodiment; and

FIG. 5 is a schematic diagram of a powder coating apparatus used for manufacturing the powder layer composite according to the embodiment.

### DETAILED DESCRIPTIONS

(Background to Obtaining One Aspect of Present Disclosure)

The present inventors have found that a powder layer formed on a surface of a current collector has the following problems. Even when a thickness of the powder layer is made uniform by a squeegee as in PTL 1, a variation in a weight per unit area of a powder occurs in a large-sized powder layer. Therefore, a problem is likely to occur in quality of a large-sized energy device using such a powder layer. The weight per unit area of the powder is a value indicating an amount of the powder per unit area by weight, and a unit of the weight per unit area is, for example, g/cm².

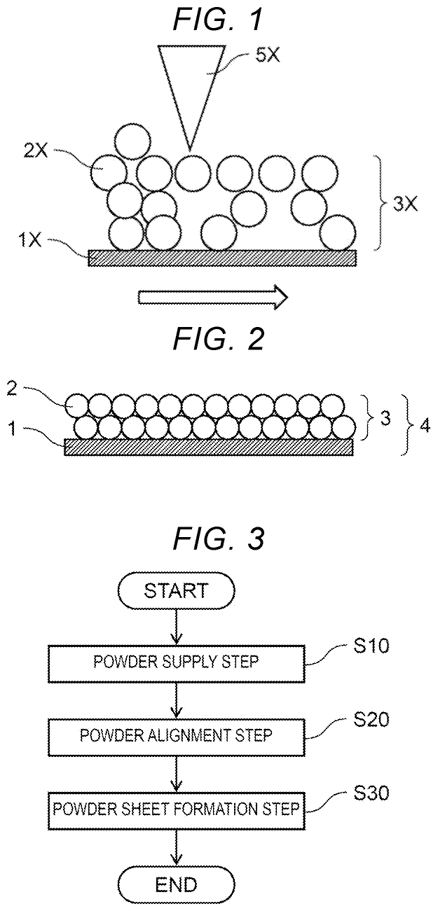

Here, a variation in the powder layer will be specifically described with reference to FIG. 1. FIG. 1 is a schematic diagram illustrating a powder layer according to a comparative example. A white arrow in FIG. 1 indicates a conveying direction for current collector 1X. Squeegee 5X shown in FIG. 1 is fixed to form a gap with current collector 1X. As shown in FIG. 1, when current collector 1X is conveyed, powder 2X is smoothed by squeegee 5X, and a film thickness of powder layer 3X is controlled to be constant. However, since it is not possible to control a variation in a filling state (sparseness and denseness) of powder 2X, it is difficult to control a weight per unit area of powder layer 3X to be constant.

In a thin-layered energy device such as an all-solid-state battery, it is required to improve performance of the energy device by improving quality of the powder layer. The present disclosure provides a powder layer composite for an energy device or the like that can improve the performance of the energy device. Specifically, in the present disclosure, a large-sized powder layer having a small variation in a weight per unit area is formed on a current collector. This will be described in detail below.

(Outline of Present Disclosure)

An outline of an aspect of the present disclosure is as follows.

A powder layer composite for an energy device according to the aspect of the present disclosure includes: a current collector; and a powder layer formed on the current collector and having a film thickness of 50 μm or more, in which the powder layer contains a powder made of at least one type of particle material, a concentration of a solvent contained in the powder layer is 50 ppm or less, and a variation in a weight per unit area of the powder layer is 10% or less in an optional region with 30 mm×30 mm in the powder layer.

Accordingly, a powder layer composite is implemented in which the variation in the weight per unit area of the powder layer is small and deterioration of the powder layer due to the solvent is prevented. Therefore, by using such a powder layer composite for an energy device, an output and quality of the energy device can be improved, and performance of the energy device can be improved.

For example, a filling rate of the powder in the powder layer may be equal to or higher than a tap filling rate of the powder.

Accordingly, as compared with a case where the powder is filled by tapping, a void between powders in the powder layer is reduced, and the variation in the weight per unit area of the powder layer can be further reduced.

For example, the at least one type of particle material may contain a main powder that is a particle material having the largest volume ratio among the at least one type of particle material, a particle size distribution of the main powder represented by (D90−D10)/D50 may be larger than 75%, and the filling rate of the powder in the powder layer may be 1.1 times or more the tap filling rate of the powder.

When the particle size distribution of the powder is large, fluidity of the powder deteriorates, and the variation in the weight per unit area of the powder layer is likely to occur, but when the filling rate of the powder in the powder layer is higher by 10% or more than that in a case where the powder is filled by tapping, the void between the powders in the powder layer can be further reduced, and the variation in the weight per unit area of the powder layer can be further reduced.

For example, a filling rate of the powder in the powder layer may be 80% or more.

Accordingly, contact between the powders is increased, and the performance of the energy device using the powder layer composite can be further improved.

For example, the current collector may be a positive electrode current collector, and the powder may contain a positive electrode active material and a solid electrolyte having ion conductivity as the at least one type of particle material.

Accordingly, the powder layer composite can be used as a positive electrode in an all-solid-state battery.

For example, the current collector may be a negative electrode current collector, and the powder may contain a negative electrode active material and a solid electrolyte having ion conductivity as the at least one type of particle material.

Accordingly, the powder layer composite can be used as a negative electrode in the all-solid-state battery.

A method for manufacturing a powder layer composite for an energy device according to an aspect of the present disclosure includes: supplying a powder onto a surface of a current collector to form a powder layer containing the powder; and adjusting a thickness of the powder layer and a filling rate of the powder in the powder layer by using the squeegee vibrated at a frequency of 2 kHz or more and 300 kHz or less, while relatively moving the current collector in a predetermined direction with respect to a squeegee disposed to form a gap with the current collector, in which in the adjusting of the thickness of the powder layer and the filling rate of the powder in the powder layer, the powder in the powder layer is filled such that the filling rate of the powder in the powder layer is equal to or higher than a tap filling rate of the powder.

Accordingly, the filling rate of the powder in the powder layer is increased, and an amount of a void portion in the formed powder layer is reduced. As a result, a powder layer composite having a small variation in the weight per unit area of the powder layer can be manufactured by reducing the amount of the void portion that causes sparseness and denseness of the powder in the powder layer. Therefore, by using such a powder layer composite for an energy device, the output and the quality of the energy device can be improved, and the performance of the energy device can be improved.

For example, the powder may contain at least one type of particle material, the at least one type of particle material may contain a main powder that is a material particle having the largest volume ratio among the at least one type of particle material, a particle size distribution of the main powder represented by (D90−D10)/D50 may be larger than 75%, and in the adjusting of the thickness of the powder layer and the filling rate of the powder in the powder layer, the powder in the powder layer may be filled such that the filling rate of the powder in the powder layer is 1.1 times or more the tap filling rate of the powder.

Accordingly, when the particle size distribution of the powder is large, the fluidity of the powder deteriorates, and the variation in the weight per unit area of the powder layer is likely to occur, but by setting the filling rate of the powder in the powder layer to be higher by 10% or more than that in a case where the powder is filled by tapping, the void between the powders in the powder layer can be further reduced, and the variation in the weight per unit area of the powder layer can be further reduced.

For example, the adjusting of the thickness of the powder layer and the filling rate of the powder in the powder layer may include ejecting a part of the powder in the powder layer to a position where a height from the current collector is higher than the gap.

Accordingly, it is possible to confirm a high filling status of the powder without measuring the filling rate of the powder in the powder layer by using a separate measuring device or the like, and it is possible to easily and reliably stabilize quality of the powder layer.

For example, the adjusting of the thickness of the powder layer and the filling rate of the powder in the powder layer may include scraping off the ejected part of the powder with the squeegee to adjust the thickness of the powder layer.

Accordingly, the part of the powder ejected to an upper portion of the powder layer can be removed, the thickness of the powder layer can be made constant, and the variation in the weight per unit area of the powder layer can be reduced.

A powder coating apparatus for an energy device according to an aspect of the present disclosure includes: a powder supply unit that supplies a powder onto a surface of a current collector; a squeegee that is disposed to form a gap with the current collector, that is vibrated at a frequency of 2 kHz or more and 300 kHz or less, and that adjusts a weight per unit area and a filling rate of the powder supplied onto the surface of the current collector by the powder supply unit; a drive unit that relatively moves the current collector in a predetermined direction with respect to the squeegee; and a control unit that controls at least one of the gap and vibration of the squeegee.

Accordingly, the control unit controls at least one of the gap between the squeegee and the current collector and the vibration of the squeegee, so that it is possible to increase the filling rate of the powder layer formed of the powder supplied onto the surface of the current collector, which is adjusted by the squeegee. Therefore, by using the powder coating apparatus, it is possible to manufacture a powder layer composite in which the filling rate of the powder layer is increased and the variation in the weight per unit area of the powder layer is reduced. Therefore, by using such a powder layer composite for an energy device, the output and the quality of the energy device can be improved, and the performance of the energy device can be improved.

Hereinafter, an embodiment of the present disclosure will be described with reference to the drawings.

The embodiment to be described below shows a comprehensive or specific example. Numerical values, shapes, materials, components, arrangement positions and connection forms of the components, steps, an order of the steps, and the like shown in the following embodiments are mere examples, and are not intended to limit the present disclosure. Among components in the following embodiments, components not recited in independent claims are described as optional components.

In the present specification, a term indicating a relationship between elements such as parallel, and a term indicating a shape of an element such as a rectangle, and a numerical range are not expressions indicating only a strict meaning, but are expressions meaning that a substantially equivalent range, for example, a difference of about several % is included.

Each drawing is a schematic diagram in which emphasis, omission, or adjustment of a ratio is appropriately performed in order to illustrate the present disclosure, is not necessarily strictly shown, and may be different from an actual shape, an actual positional relationship, and an actual ratio. In each drawing, substantially the same configuration is denoted by the same reference numeral, and redundant description may be omitted or simplified.

In the present specification, terms “upper” and “lower” of a configuration of the all-solid-state battery do not refer to an upper direction (vertically upward) and a lower direction (vertically downward) in absolute space recognition, but are used as terms defined by a relative positional relationship based on a stacking order of a stacking configuration. The terms “upper” and “lower” are applied not only to a case where two components are arranged in close contact with each other and the two components are in contact with each other, but also to a case where two components are arranged at an interval from each other and another component exists between the two components.

In the present specification, each schematic diagram shows the powder layer composite when viewed from a direction perpendicular to a thickness direction of the powder layer.

### Embodiment

[Configuration of Powder Layer Composite]

First, a configuration of a powder layer composite according to an embodiment will be described. FIG. 2 is a schematic diagram of powder layer composite 4 according to the embodiment.

As shown in FIG. 2, powder layer composite 4 includes current collector 1 and powder layer 3 formed on current collector 1. Powder layer composite 4 is a powder layer composite for an energy device, and is used as, for example, an electrode in the energy device. Powder layer composite 4 may further include another layer, such as a connection layer made of a conductive carbon material or the like, positioned between current collector 1 and powder layer 3.

Powder layer 3 has a film thickness of 50 μm or more. An upper limit of the film thickness of powder layer 3 is not particularly limited, and is, for example, 1000 μm or less.

Powder layer 3 contains powder 2 made of at least one type of particle material. Powder layer 3 is made of, for example, powder 2.

A concentration of a solvent contained in powder layer 3 is 50 ppm or less. That is, powder layer 3 is substantially free of a solvent. The expression “substantially free of” means a case where it is not contained at all, and a case where it is inevitably contained at 50 ppm or less as an impurity. The concentration of the solvent is a concentration on a weight basis.

A size of powder layer 3 in a plan view is, for example, 30 mm×30 mm or more. An upper limit of the size of powder layer 3 in the plan view is not particularly limited, and is, for example, 300 mm×500 mm or less.

In an optional region with 30 mm×30 mm in powder layer 3, a variation in a weight per unit area of powder layer 3 is 10% or less. Here, the weight per unit area represents a weight of powder 2 per unit area, and can be represented by a unit of, for example, g/cm².

As a method for measuring the weight per unit area, for example, the following method is used. First, powder layer composite 4 is compacted by being pressed from above and below, then powder layer composite 4 is punched into a circle having a diameter of 5 mm or more and 9 mm or less, and a total weight of punched powder layer 3 and current collector 1 is measured. A weight of current collector 1 of the same lot punched out with a diameter of 5 mm or more and 9 mm or less is measured in advance. A weight of powder layer 3 is obtained by subtracting a weight of current collector 1 from the total weight. The weight per unit area can be obtained by dividing the weight by an area of the circle having a diameter of 5 mm or more and 9 mm or less.

Measurement of a variation in the weight per unit area is performed by, for example, the following method. First, an optional region with 30 mm×30 mm in powder layer composite 4 in a plan view is selected. The region may be a region on a central portion of powder layer composite 4, or may be a region including an end portion of powder layer composite 4. In a range of the region, for example, five or more circular portions having a diameter of 5 mm or more and 9 mm or less are punched out, and the weight per unit area is measured using the above-described method. From a viewpoint of increasing accuracy of measurement of the variation, nine or more portions may be punched out. The variation in the weight per unit area is calculated by dividing a difference (specifically, an absolute value of the difference) between an average of weight per unit areas of all the punched portions and a weight per unit area of a portion having the largest difference from the average among weight per unit areas of the punched portions by the average. That is, the expression “the variation in the weight per unit area is 10% or less” means that the difference from the average of the weight per unit areas is 10% or less of the average at any of the punched portions.

A filling rate of powder 2 in powder layer 3 is equal to or higher than a tap filling rate of powder 2. Accordingly, in powder layer 3, sparseness and denseness of powder 2 is unlikely to occur, and the variation in the weight per unit area of powder layer 3 can be reduced.

The filling rate of powder 2 in powder layer 3 is a ratio of a true volume of powder 2 to an apparent volume of powder layer 3, and can be obtained by, for example, dividing the weight per unit area by a thickness (unit is, for example, cm) of powder layer 3. As will be described later, since powder 2 passes through squeegee 5 to manufacture powder layer 3, the thickness of powder layer 3 is, for example, a thickness after powder 2 passing through squeegee 5.

The tap filling rate of powder 2 is a value obtained by dividing a tap density of powder 2 by a true density of powder 2. The tap density and the true density can be expressed in units of, for example, g/cm³.

The tap density is an apparent density when a container having a predetermined size is filled with powder 2 while the container is tapped, and is measured by, for example, the following method.

First, powder 2 is gently poured into a container having a space with a diameter of 20 mm and a height of 20 mm until powder 2 overflows from the container. Then, a tap operation is performed on the container into which powder 2 is poured. Specifically, the tap operation is performed 100 times at a tap speed of 100 times/30 seconds and a height of 10 mm. Thereafter, powder 2 is gently added until powder 2 overflows from the container, and the tap operation is performed again. After the supply of powder 2 to the container and the tap operation are repeated 10 times, a linear spatula that is brought into contact with an upper surface of the container in a perpendicularly upright manner is smoothly moved to scrape off powder 2 overflowing to a height equal to or higher than a height of the space of the container, that is, surplus powder 2 above the upper surface of the container.

The tap density (g/cm³) of powder 2 can be obtained by measuring a weight of powder 2 contained in the container after such an operation and dividing the weight by a capacity of the container. The tap filling rate of powder 2 can be obtained by dividing the tap density of powder 2 by the true density of powder 2.

When powder 2 is a mixture powder made of a plurality of types of particle materials, a tap filling rate of the mixture powder is obtained.

In the present embodiment, it is possible to implement powder layer composite 4 in which the variation in the weight per unit area of powder layer 3 is small even in a case of a powder in which a variation in a particle size of powder 2 is large and fluidity of powder 2 deteriorates.

In powder layer 3, a particle size distribution of a main powder represented by (D90−D10)/D50 may be larger than 75%. The main powder is a particle material having the largest volume ratio among at least one type of particle material that constitutes powder 2. In this case, the filling rate of powder 2 in powder layer 3 may be 1.1 times or more the tap filling rate of powder 2. Accordingly, the variation in the weight per unit area of powder layer 3 can be reduced. When powder 2 contains a plurality of types of particle materials, since powder 2 is easily influenced by the particle material having the largest volume ratio, attention is paid to the particle size distribution of the main powder having the largest volume ratio.

When the fluidity of powder 2 deteriorates, since powder 2 is unlikely to be arranged, a void between powders 2 in powder layer 3 is more likely to be biased, and the variation in the weight per unit area is likely to occur. Therefore, by increasing the filling rate of powder 2, it is possible to reduce an amount of void portions and to prevent the variation in the weight per unit area.

A reason why the fluidity deteriorates when the particle size distribution of powder 2 is large is considered to be that large particles and small particles are combined and the powders are easily aggregated, resulting in deterioration of the fluidity.

In (D90−D10)/D50 representing the particle size distribution, D10, D50, and D90 represent particle sizes based on a volume-based particle size distribution. Specifically, on a volume basis, a particle size when a cumulative frequency is 10% is represented by D10, a particle size when the cumulative frequency is 50% is represented by D50, and a particle size when the cumulative frequency is 90% is represented by D90. D50 is also referred to as a median diameter. The particle size distribution is measured using, for example, a commercially available laser analysis and scattering type particle size distribution measuring device. The particle size distribution may be determined by analyzing an image using a scanning electron microscope (SEM).

The filling rate of powder 2 in powder layer 3 is, for example, 80% or more. Accordingly, contact between powders 2 increases, and the performance of the energy device using powder layer composite 4 can be further improved.

Although details will be described later, powder layer 3 is formed by, for example, applying high-frequency vibration to powder 2 to fill powder 2 in powder layer 3 while imparting fluidity to powder 2. Accordingly, powder layer 3 having a size of 30 mm×30 mm or more and a thickness of 50 μm or more can be produced, and powder layer 3 can be used for a large high-capacity energy device.

Powder layer 3 can be produced through, for example, a solvent-free coating step to form powder layer 3 that is substantially free of a solvent. Accordingly, powder layer 3 is not damaged by the solvent. Therefore, powder layer composite 4 in which deterioration of powder layer 3 is prevented and the variation in the weight per unit area of powder 2 in powder layer 3 is small is formed, and it is possible to implement powder layer composite 4 for a large high-capacity energy device having high output and excellent quality.

Powder layer composite 4 can be used for, for example, a positive electrode or a negative electrode in the energy device such as an all-solid-state battery.

When powder layer composite 4 is a positive electrode, for example, current collector 1 is a positive electrode current collector, and powder layer 3 containing powder 2 is a positive electrode mixture layer. The positive electrode mixture layer is formed on the positive electrode current collector. Powder 2 in the positive electrode mixture layer contains a positive electrode active material and a solid electrolyte having ion conductivity as at least one type of particle material.

When powder layer composite 4 is a negative electrode, for example, current collector 1 is a negative electrode current collector, and powder layer 3 containing powder 2 is a negative electrode mixture layer. The negative electrode mixture layer is formed on the negative electrode current collector. Powder 2 in the negative electrode mixture layer contains a negative electrode active material and a solid electrolyte having ion conductivity as at least one type of particle material.

The positive electrode mixture layer and the negative electrode mixture layer can be produced by a manufacturing method described later by using the following materials for powder 2.

A concentration of a solvent contained in the positive electrode mixture layer and the negative electrode mixture layer is 50 ppm or less. That is, the positive electrode mixture layer and the negative electrode mixture layer are substantially free of a solvent. The expression “substantially free of” means a case where it is not contained at all, and a case where it is inevitably contained at 50 ppm or less as an impurity.

The solvent is, for example, an organic solvent. A method for measuring the solvent is not particularly limited, and the solvent can be measured using, for example, gas chromatography or a mass change method. Examples of the organic solvent include non-polar organic solvents such as heptane, xylene, and toluene, polar organic solvents such as a tertiary amine-based solvent, an ether-based solvent, a thiol-based solvent, and an ester-based solvent, and a combination thereof. Examples of the tertiary amine-based solvent include triethylamine, tributylamine, and triamylamine. Examples of the ether-based solvent include tetrahydrofuran and cyclopentyl methyl ether. Examples of the thiol-based solvent include ethane mercaptan. Examples of the ester-based solvent include butyl butyrate, ethyl acetate, and butyl acetate.

Next, details of materials used for the positive electrode mixture layer and the negative electrode mixture layer will be described.

The positive electrode active material is a material in which ions of a metal such as lithium (Li) are inserted into or removed from a crystal structure at a potential higher than that of the negative electrode, and oxidation or reduction is performed along with the insertion or removal of ions of a metal such as lithium. A type of the positive electrode active material is appropriately selected in accordance with a type of the all-solid-state battery, and examples thereof include an oxide active material and a sulfide active material.

As the positive electrode active material in the present embodiment, for example, an oxide active material (lithium-containing transition metal oxide) is used. Examples of the oxide active material include LiCoO₂, LiNiO₂, LiMn₂O₄, LiCoPO₄, LiNiPO₄, LiFePO₄, LiMnPO₄ and a compound obtained by substituting a transition metal in these compounds with one or two different elements. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compound obtained by substituting the transition metal in the above compounds with one or two different elements. The positive electrode active material may be used alone or in combination of two or more thereof.

Examples of a shape of the positive electrode active material include a particulate shape and a thin film shape. When the positive electrode active material has a particulate shape, a particle size of the positive electrode active material may be in a range of, for example, 50 nm or more and 50 μm or less, or may be in a range of 1 μm or more and 15 μm or less. When the particle size of the positive electrode active material is set to 50 nm or more, handleability is likely to be improved. In contrast, when the particle size is set to 50 μm or less, by using an active material having a small particle size, a surface area is increased, and a high-capacity positive electrode is easily obtained. A particle size of a material contained in the positive electrode mixture layer or the negative electrode mixture layer in the present specification is, for example, D50 described above.

A content of the positive electrode active material in the positive electrode mixture layer is not particularly limited, and for example, may be in a range of 40% by weight or more and 99% by weight or less, or may be 70% by weight or more and 95% by weight or less.

A surface of the positive electrode active material may be coated with a coating layer. This is because a reaction between the positive electrode active material (for example, an oxide active material) and the solid electrolyte (for example, a sulfide-based solid electrolyte) can be prevented. Examples of a material of the coating layer include, Li ion conductive oxides such as LiNbO₃, Li₃PO₄, and LiPON. An average thickness of the coating layer may be in a range of, for example, 1 nm or more and 20 nm or less, or may be in a range of 1 nm or more and 10 nm or less.

When a ratio between the positive electrode active material and the solid electrolyte contained in the positive electrode mixture layer is positive electrode active material/solid electrolyte=a weight ratio in terms of weight, the weight ratio may be in a range of 1 or more and 19 or less, or may be in a range of 2.3 or more and 19 or less. When the weight ratio is within this range, both a lithium ion conduction path and an electron conduction path in the positive electrode mixture layer are easily secured.

The negative electrode active material is a material in which ions of a metal such as lithium are inserted into or removed from a crystal structure at a potential lower than that of the positive electrode, and oxidation or reduction is performed along with the insertion or removal of ions of a metal such as lithium.

Known materials such as lithium, an easily alloyed metal with lithium such as indium, tin, and silicon, a carbon material such as hard carbon and graphite, and an oxide active material such as Li₄Ti₅O₁₂ and SiOₓ are used as the negative electrode active material in the present embodiment. In addition, a composite in which the above-described negative electrode active materials are appropriately mixed may also be used as the negative electrode active material.

A particle size of the negative electrode active material is, for example, 50 μm or less. Since an active material having a small particle size is used, a surface area can be increased, and a capacity can be increased.

When a ratio between the negative electrode active material and the solid electrolyte contained in the negative electrode mixture layer is negative electrode active material/solid electrolyte=a weight ratio in terms of weight, for example, the weight ratio may be in a range of 0.6 or more and 19 or less, or may be in a range of 1 or more and 5.7 or less. When the weight ratio is within this range, both a lithium ion conduction path and an electron conduction path in the negative electrode mixture layer are easily secured.

The solid electrolyte may be appropriately selected in accordance with a conductive ion species (for example, lithium ion), and can be roughly divided into, for example, a sulfide-based solid electrolyte, an oxide-based solid electrolyte, and a halide-based solid electrolyte.

A type of the sulfide-based solid electrolyte in the present embodiment is not particularly limited, and examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. Particularly, from a viewpoint of excellent lithium ion conductivity, the sulfide-based solid electrolyte may contain Li, P, and S. The sulfide-based solid electrolyte may be used alone or in combination of two or more thereof. The sulfide-based solid electrolyte may be crystalline, amorphous, or glass-ceramic. The above description of “Li₂S—P₂S₅” means a sulfide-based solid electrolyte using a raw material composition containing Li₂S and P₂S₅, and the same applies to other descriptions.

In the present embodiment, one form of the sulfide-based solid electrolyte is sulfide glass ceramics containing Li₂S and P₂S₅. When a ratio of Li₂S to P₂S₅ is Li₂S/P₂S₅=molar ratio in terms of mole, for example, the molar ratio may be in a range of 2.3 or more and 4 or less, or may be in a range of 3 or more and 4 or less. When the molar ratio is within this range, a crystal structure having high ion conductivity can be obtained while maintaining a lithium concentration that influences battery characteristics.

Examples of a shape of the sulfide-based solid electrolyte in the present embodiment include a particle shape such as a true spherical shape and an elliptical spherical shape, and a thin film shape. When the sulfide-based solid electrolyte material has a particle shape, a particle size of the sulfide-based solid electrolyte is not particularly limited, and may be 40 μm or less, 20 μm or less, or 10 μm or less in order to easily improve a filling rate in the positive electrode or the negative electrode. In contrast, the particle size of the sulfide-based solid electrolyte may be 0.001 μm or more, or may be 0.01 μm or more.

Next, the oxide-based solid electrolyte in the present embodiment will be described. A type of the oxide-based solid electrolyte is not particularly limited, and examples thereof include LiPON, Li₃PO₄, Li₂SiO₂, Li₂SiO₄, Li_{0.5}La_{0.5}TiO₃, Li_{1.3}Al_{0.3}Ti_{0.7}(PO₄)₃, La_{0.51}Li_{0.34}TiO_{0.74}, and Li_{1.5}Al_{0.5}Ge_{1.5}(PO₄)₃. The oxide-based solid electrolyte may be used alone or in combination of two or more thereof.

Next, details of the positive electrode current collector and the negative electrode current collector will be described.

The positive electrode in the present embodiment includes, for example, a positive electrode current collector made of a metal foil or the like. For example, a foil-shaped body, a plate-shaped body, or a mesh-shaped body made of aluminum, gold, platinum, zinc, copper, SUS, nickel, tin, titanium, or an alloy of two or more of these metals is used for the positive electrode current collector.

A thickness, a shape, and the like of the positive electrode current collector may be appropriately selected in accordance with an application of the positive electrode.

The negative electrode in the present embodiment includes, for example, a negative electrode current collector made of a metal foil or the like. For example, a foil-shaped body, a plate-shaped body, or a mesh-shaped body made of SUS, gold, platinum, zinc, copper, nickel, titanium, tin, or an alloy of two or more of these metals is used for the negative electrode current collector.

A thickness, a shape, and the like of the negative electrode current collector may be appropriately selected in accordance with an application of the negative electrode.

[Method for Manufacturing Powder Layer Composite]

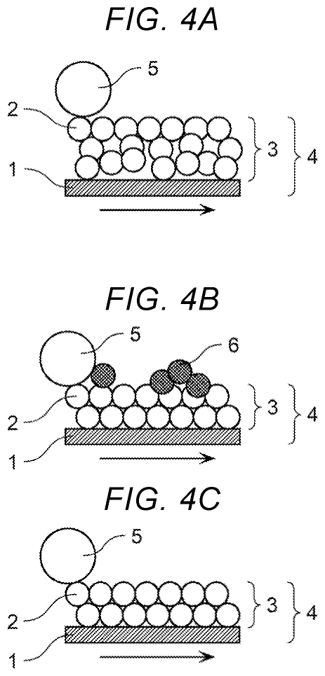

Next, a method for manufacturing the powder layer composite according to the present embodiment will be described with reference to FIGS. 3, 4A, 4B, and 4C.

FIG. 3 is a flowchart showing a method for manufacturing powder layer composite 4 according to the embodiment. Powder layer composite 4 is formed through, for example, three steps.

As shown in FIG. 3, the method for manufacturing powder layer composite 4 includes, for example, a powder supply step (S10) and a powder alignment step (S20), and may further include a powder sheet formation step (S30) if necessary.

First, powder 2 used in the powder supply step is prepared. A raw material of powder 2 is not particularly limited, and for example, a mixture powder containing the active material as described above may be used as powder 2. The active material, the solid electrolyte, and if necessary, additives such as a binder and a conductive material are mixed to produce powder 2. Examples of a mixing method include a method of mixing using a mortar, a ball mill, a mixer, or the like. The mixing method may be, for example, a method of mixing the particle materials without using a solvent or the like. Accordingly, material deterioration of powder 2 can be prevented.

In the powder supply step (S10), powder 2 is supplied onto the surface of current collector 1 to form powder layer 3. For example, powder 2 is supplied onto the surface of current collector 1 by using a powder supply unit such as a hopper while moving current collector 1 in a predetermined direction by using a conveyance device. Current collector 1 may have a sheet shape. In the powder supply step, for example, powder 2 is supplied onto the surface of current collector 1 without using a solvent. Accordingly, powder layer 3 substantially free of a solvent is formed. When powder 2 is supplied, the powder supply unit may be moved in a predetermined direction with respect to current collector 1 instead of moving current collector 1.

Next, in the powder alignment step (S20), the thickness of powder layer 3 and the filling rate of powder 2 in powder layer 3 are adjusted by using a squeegee. For example, in the powder alignment step, powder 2 is aligned on the surface of current collector 1 by using the squeegee. The weight per unit area of powder 2 supplied onto the surface of current collector 1 is adjusted using the squeegee. That is, in the powder alignment step, the weight per unit area of powder layer 3 formed in the powder supply step is adjusted to a desired value. At this time, the squeegee is vibrated at a frequency of 2 kHz or more and 300 kHz or less. Details of the powder alignment step will be described later.

In the powder sheet formation step (S30), powder 2 aligned on current collector 1, that is, powder layer 3 in which the thickness and the filling rate described above are adjusted is compressed by pressing or the like. Accordingly, powder layer 3 on the surface of current collector 1 is compressed, and the filling rate of powder layer 3 is further increased. For example, the filling rate of powder layer 3 through the powder sheet formation step is 80% or more. Since powder layer 3 is compressed and compacted, powder 2 does not come apart, so that transportability of powder layer composite 4 is improved.

As described above, in the method for manufacturing powder layer composite 4, powder layer composite 4 in which powder layer 3 containing powder 2 is formed on the surface of current collector 1 is obtained by sequentially performing the powder supply step (S10), the powder alignment step (S20), and the powder sheet formation step (S30). Such powder layer composite 4 including current collector 1 and powder layer 3 can be used for an energy device. For example, when the powder containing the active material is used as powder 2, the electrode of the battery can be manufactured.

Next, the powder alignment step (S20) will be described in detail with reference to FIGS. 4A, 4B and 4C.

In the powder alignment step, by filling powder 2, voids in powder layer 3 can be reduced, a difference in the sparseness and denseness of powder 2 in powder layer 3 can be reduced, and the variation in the weight per unit area of powder layer 3 can be reduced.

FIG. 4A is a schematic diagram illustrating a step of filling powder 2 supplied onto the surface of current collector 1 in the powder alignment step. FIG. 4B is a schematic diagram illustrating a state where surplus powder 6 is ejected onto an upper portion of powder layer 3 in the powder alignment step. FIG. 4C is a schematic diagram illustrating a state where surplus powder 6 is scraped off and the thickness of powder layer 3 is made constant in the powder alignment step. In FIGS. 4A to 4C, a movement direction of the current collector is indicated by an arrow.

As shown in FIG. 4A, on the surface of current collector 1, powder layer 3 made of powder 2 supplied in the powder supply step is formed, and the thickness of powder layer 3 and the filling rate of powder 2 in powder layer 3 are adjusted using squeegee 5 while moving current collector 1 in a predetermined direction. At this time, powder 2 in powder layer 3 is filled such that the filling rate of powder 2 in powder layer 3 is equal to or higher than the tap filling rate of powder 2. Accordingly, powder layer composite 4 including current collector 1 and powder layer 3 is formed. Instead of moving current collector 1, squeegee 5 may be moved in a predetermined direction. That is, current collector 1 is relatively moved in a predetermined direction with respect to squeegee 5. The predetermined direction is a direction perpendicular to a thickness direction of current collector 1, and for example, when current collector 1 is a long sheet, the predetermined direction is a longitudinal direction of current collector 1.

Squeegee 5 is disposed to form a gap with current collector 1. The gap is set in accordance with the thickness of powder layer 3 to be formed. Squeegee 5 is vibrated at a frequency of 2 kHz or more and 300 kHz or less. That is, squeegee 5 is vibrated at a high frequency near an ultrasonic band. In the powder alignment step, the thickness of powder layer 3 and the filling rate of powder 2 in powder layer 3 are adjusted by using squeegee 5 vibrated at a frequency of 2 kHz or more and 300 kHz or less in this way. Since the fluidity of powder 2 is increased by vibrating squeegee 5 at a high frequency near the ultrasonic band, powder 2 is aligned and filled.

The fluidity of powder 2 is likely to increase as the frequency of the vibration of squeegee 5 increases. Therefore, the fluidity of powder 2 can be sufficiently increased by vibrating squeegee 5 at a frequency of 2 kHz or more in a high-frequency region near the ultrasonic band. Since the high frequency near the ultrasonic band is likely to be attenuated, when the frequency is too high, vibration is unlikely to be transmitted, but by vibrating squeegee 5 at a frequency of 300 kHz or less, the fluidity of powder 2 can be sufficiently increased. When squeegee 5 is vibrated at a high frequency near the ultrasonic band, powder 2 in contact with squeegee 5 is unlikely to be subjected to frictional resistance due to a powder pressure, and the fluidity is increased, whereby powder 2 is aligned and filled.

In this way, current collector 1 is moved in the predetermined direction, powder 2 on the upper portion of powder layer 3 passes through squeegee 5 while being in contact with squeegee 5, and squeegee 5 is vibrated at a high frequency near the ultrasonic band, whereby powder 2 flows and is aligned, and therefore the filling rate of powder 2 in powder layer 3 is increased. In order to improve the filling rate of powder 2, powder 2 may be passed through squeegee 5 a plurality of times. When powder 2 is passed through squeegee 5 the plurality of times, current collector 1 may be moved in the same direction every time, or current collector 1 may be moved while alternately reversing the movement direction.

A direction of the high-frequency vibration near the ultrasonic band for squeegee 5 may be only a perpendicular direction or only a horizontal direction with respect to a surface of squeegee 5.

The perpendicular direction is a direction perpendicular to a main surface of squeegee 5 facing powder layer 3. In the vibration in the perpendicular direction, a longitudinal wave (a wave in a direction in which squeegee 5 is vibrated to approach and separate from powder 2) is easily transmitted to powder 2.

A vibration component in the perpendicular direction has a large effect on reducing frictional resistance between powders 2. Specifically, since the vibration in the perpendicular direction is a direction in which squeegee 5 is vibrated to approach and separate from powder 2, collision between powders 2 is repeated, and vibration is easily transmitted to powder 2. Since the high frequency near the ultrasonic band has a high frequency, it may be difficult for the vibration between powders 2 to be transmitted. However, when the vibration is in the perpendicular direction, the vibration is particularly easily transmitted to powder 2.

Particularly, the vibration component in the perpendicular direction can greatly move powders 2 in an accumulation portion in which powders 2 are accumulated. Accordingly, since powders 2 are more likely to collide with each other, powders 2 are more likely to flow.

The horizontal direction is a direction parallel to the main surface of squeegee 5 facing powder layer 3 and parallel to an axis of squeegee 5. In the vibration in the horizontal direction, a transverse wave (a wave in a direction in which squeegee 5 rubs against powder 2 and is vibrated) is easily transmitted to powder 2. The axis of squeegee 5 means, for example, when powder layer 3 has a long shape, an axis in a direction parallel to a width direction in a direction perpendicular to a longitudinal direction of powder layer 3. When squeegee 5 has a long shape such as a columnar shape, the axis of squeegee 5 may be parallel to a longitudinal direction of squeegee 5.

The main surface of squeegee 5 is, for example, a surface parallel to an upper surface of current collector 1. In the vibration of squeegee 5, high-frequency vibration near the ultrasonic band in both the perpendicular direction and the horizontal direction may be used in combination. Accordingly, the fluidity of powder 2 can be further increased. This is because, when attention is paid to a single powder, a vibration direction of powder 2 is random, and vibration is applied to the entire surface of the powder, so that vibration is not transmitted, there is no surface having high frictional resistance, and the fluidity is increased.

When squeegee 5 is vibrated at a high frequency near the ultrasonic band in the perpendicular direction and the horizontal direction, a magnitude of the vibration of squeegee 5 in the horizontal direction may be larger than a magnitude of the vibration of squeegee 5 in the perpendicular direction. That is, in the vibration of squeegee 5, a magnitude of vibration of a transverse wave component (in a direction in which a surface of squeegee 5 and a surface of powder 2 are vibrated to rub against each other) of powder 2 may be larger than a magnitude of vibration of a longitudinal wave component (in the direction in which squeegee 5 is vibrated to approach and separate from powder 2) of powder 2. The high-frequency vibration in the horizontal direction near the ultrasonic band of squeegee 5 greatly contributes to a reduction in a frictional force between squeegee 5 and powder 2 in addition to the reduction in the frictional resistance between powders 2. Therefore, frictional resistance at an interface between squeegee 5 and powder 2, which is particularly likely to be high, can be reduced by the vibration of squeegee 5 in the horizontal direction, and the frictional resistance between powders 2 can also be reduced, so that the fluidity of powder 2 can be further increased.

The magnitude of the vibration of squeegee 5 in the perpendicular direction is, for example, 2 μm or more. That is, an amplitude of squeegee 5 in the perpendicular direction is, for example, 2 μm or more. Accordingly, the frictional resistance between powders 2 can be sufficiently reduced, and the fluidity of powder 2 can be further increased. An amplitude of squeegee 5 in the perpendicular direction is, for example, 20 μm or less. Accordingly, it is possible to prevent powder 2 from greatly vibrating in the perpendicular direction and to reduce a variation in the film thickness.

The magnitude of the vibration of squeegee 5 in the horizontal direction is, for example, 4 μm or more. That is, an amplitude of squeegee 5 in the horizontal direction is, for example, 4 μm or more. Accordingly, the frictional resistance at the interface between squeegee 5 and powder 2 can be sufficiently reduced, and the fluidity of powder 2 can be further increased. The amplitude of squeegee 5 in the horizontal direction is, for example, 40 μm or less. Accordingly, it is possible to prevent powder 2 from greatly vibrating in the horizontal direction, and to reduce a size variation of powder layer 3 in a width direction due to large movement of powder 2 at an end portion of powder layer 3 in a width direction.

Squeegee 5 has, for example, a columnar shape, and is disposed such that, for example, an axial direction of a column (a height direction of the column) is parallel to the upper surface of current collector 1 and intersects (for example, is orthogonal to) the movement direction of current collector 1. Columnar squeegee 5 is disposed by fixing both ends in the axial direction of the column of squeegee 5 by support columns with bearings so as to slide in the horizontal direction. In this case, by making a shape in which an axial center of squeegee 5 is inserted into an aperture of the circular bearing, it is possible to create a relationship in which the amplitude in the horizontal direction is larger than the amplitude in the perpendicular direction.

In this way, by increasing the filling rate of powder 2 in powder layer 3, the variation in the weight per unit area of powder layer 3 can be reduced, and good powder layer 3 can be obtained. In the powder alignment step, in order to adjust the thickness of powder layer 3 and the filling rate of powder 2 in powder layer 3, for example, at least one of the gap between squeegee 5 and current collector 1, the vibration (for example, at least one of the frequency and the amplitude) of squeegee 5, and the number of times powder 2 is passed through squeegee 5 is adjusted.

When the filling rate of powder 2 is low, the difference in the sparseness and denseness of powder 2 in powder layer 3 becomes large. Therefore, the variation in the weight per unit area of powder layer 3 also increases. Therefore, as described above, powder 2 is aligned, and the filling rate of powder 2 in powder layer 3 is increased. Accordingly, the void portion in powder layer 3 is replaced with powder 2, and the amount of the void portion is reduced. Therefore, the difference in the sparseness and denseness of powder 2 in powder layer 3 is reduced, and powder layer 3 having a small variation in the weight per unit area can be obtained.

In the present embodiment, in order to further reduce the variation in the weight per unit area of powder layer 3, the following steps may be performed.

As shown in FIG. 4B, the powder alignment step includes ejecting a part of powder 2 in powder layer 3 to a position where a height from current collector 1 is higher than the gap between squeegee 5 and current collector 1. That is, surplus powder 6, which is a part of powder 2 in powder layer 3, is ejected onto the upper portion of powder layer 3.

A state where the part of powder 2 in powder layer 3 is ejected is a state where powder 2 in powder layer 3 is completely aligned and sufficiently filled. Since it is more difficult to fill powder 2 in powder layer 3, surplus powder 6 is ejected. That is, whether powder 2 is sufficiently filled in powder layer 3 can be determined by observing an ejection status of surplus powder 6 from powder layer 3. That is, it is possible to confirm a high filling status of powder 2 without measuring the filling rate of powder 2 in powder layer 3 by using a separate measuring device or the like, and it is possible to easily and reliably stabilize quality of powder layer 3.

For example, by adjusting a vibration condition of squeegee 5 and the gap between squeegee 5 and current collector 1, or by repeatedly passing powder 2 through squeegee 5, the filling rate of powder 2 in powder layer 3 is increased, and surplus powder 6 is ejected.

Such a state where surplus powder 6 is ejected is a state where the void portion in powder layer 3 is almost eliminated. That is, a state is achieved where the difference in the sparseness and denseness of powder 2 in powder layer 3, that is, the void between powders 2 that is a factor influencing the variation in the weight per unit area of powder layer 3 is almost eliminated. Therefore, by ejecting surplus powder 6, the variation in the weight per unit area of powder layer 3 is further reduced.

In this way, in a state where surplus powder 6 is ejected and powder layer 3 is sufficiently filled, the filling rate of powder 2 in powder layer 3 is equal to or higher than the tap filling rate of powder 2 or is 1.1 times or more the tap filling rate of powder 2.

The powder alignment step may include, after surplus powder 6 is ejected, scraping off surplus powder 6 with squeegee 5 to adjust the thickness of powder 2, as shown in FIG. 4C.

Since surplus powder 6 is scraped off, surplus powder 6 ejected onto the upper portion of powder layer 3 is removed, the film thickness of powder layer 3 is made constant, and the variation in the weight per unit area of powder layer 3 is reduced. In the step of scraping off surplus powder 6, an amplitude of squeegee 5 may be smaller than that in the step of filling powder 2 until surplus powder 6 is ejected. In the step of scraping off surplus powder 6, since a main purpose is to make the thickness of powder layer 3 uniform, by reducing the amplitude, surplus powder 6 can be scraped off while further ejection of surplus powder 6 is prevented. In the step of scraping off surplus powder 6, squeegee 5 may not be vibrated.

The method for removing surplus powder 6 is not limited to the method of scraping off surplus powder 6 with squeegee 5. For example, surplus powder 6 may be removed using a scraping tool other than squeegee 5, surplus powder 6 may be removed by sucking surplus powder 6 by using a suction device, or surplus powder 6 may be removed by blowing by blowing gas to surplus powder 6.

[Powder Coating Apparatus]

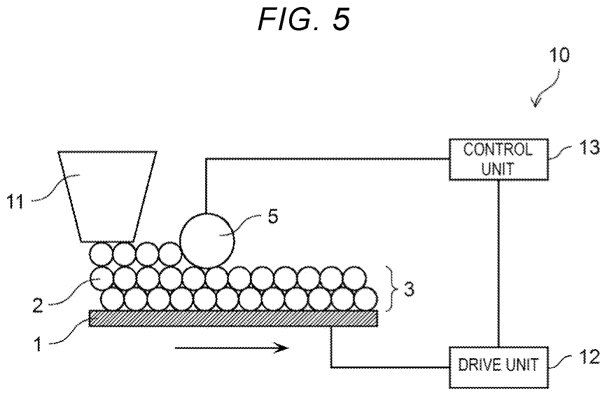

Next, a powder coating apparatus used for manufacturing the powder layer composite according to the present embodiment will be described with reference to FIG. 5. In the following description, description of content described in the method for manufacturing powder layer composite 4, such as description of squeegee 5, will be omitted or simplified.

FIG. 5 is a schematic diagram of powder coating apparatus 10 used for manufacturing powder layer composite 4 according to the present embodiment.

As shown in FIG. 5, powder coating apparatus 10 includes squeegee 5, powder supply unit 11, drive unit 12, and control unit 13. Powder coating apparatus 10 is a powder coating apparatus for an energy device, and is used for manufacturing the powder layer composite for an energy device. Powder coating apparatus 10 is an apparatus that coats the surface of current collector 1 with powder 2 while conveying current collector 1 by drive unit 12 that is a conveyance device. Specifically, powder coating apparatus 10 continuously supplies powder 2 onto the surface of current collector 1 by using powder supply unit 11 while conveying current collector 1 by drive unit 12.

Drive unit 12 is a device that moves current collector 1 in a predetermined direction. Drive unit 12 is not particularly limited as long as drive unit 12 can convey current collector 1. Drive unit 12 is, for example, a roll-to-roll conveyance device that continuously feeds out current collector 1 wound in a roll shape, but is not limited thereto. Drive unit 12 may be, for example, a conveyor type conveyance device including a conveyor on which current collector 1 is placed and moved. Drive unit 12 may intermittently feed out current collector 1. A guide roller that rotates with movement of current collector 1, a control device that corrects meandering of current collector 1, and the like may be provided on a conveyance path of current collector 1. Drive unit 12 may be a device that moves squeegee 5 and powder supply unit 11 in a predetermined direction. That is, drive unit 12 relatively moves current collector 1 in a predetermined direction with respect to squeegee 5 and powder supply unit 11.

Powder supply unit 11 supplies powder 2 onto the surface of current collector 1. Powder supply unit 11 is, for example, a hopper. The hopper stores powder 2 therein and supplies powder 2 onto the surface of current collector 1. Powder supply unit 11 is disposed upstream of squeegee 5 in the movement direction of current collector 1. Powder 2 supplied onto the surface of current collector 1 by powder supply unit 11 forms powder layer 3, and reaches squeegee 5 with movement of current collector 1. In the present embodiment, the hopper is used as powder supply unit 11, but powder supply unit 11 is not limited thereto, and may be a device that can supply powder 2 onto the surface of current collector 1. Powder supply unit 11 may be, for example, a feeder.

Squeegee 5 adjusts the weight per unit area and the filling rate of powder 2 supplied onto current collector 1 to form a coating film. In the present embodiment, squeegee 5 includes an end surface parallel to current collector 1. The shape of squeegee 5 is not particularly limited, and is, for example, a columnar shape. Squeegee 5 is vibrated at a frequency of 2 kHz or more and 300 kHz or less. For example, the frequency and the amplitude of the vibration of squeegee 5 can be adjusted. The vibration direction, the amplitude, and the like of squeegee 5 are as described in the method for manufacturing powder layer composite 4.

Squeegee 5 is disposed to form a predetermined gap with current collector 1 on a surface side of current collector 1 to which powder 2 is supplied. In addition, squeegee 5 is installed such that, for example, the gap with current collector 1 can be adjusted. The gap between squeegee 5 and current collector 1 may be adjusted by moving a position of squeegee 5, or may be adjusted by moving a position of current collector 1.

Squeegee 5 is disposed downstream of powder supply unit 11 in the movement direction of current collector 1. Accordingly, powder 2 supplied onto the surface of current collector 1 passes through the gap between squeegee 5 and current collector 1. That is, powder 2 supplied from powder supply unit 11 onto the surface of current collector 1 reaches squeegee 5 with movement of current collector 1, and is smoothed by squeegee 5. Squeegee 5 comes into contact with powder 2 supplied onto the surface of current collector 1 while vibrating, and gives fluidity to powder 2 supplied onto the surface of current collector 1, whereby powder 2 is aligned and the amount of the voids in powder layer 3 are reduced. That is, the filling rate of powder 2 in powder layer 3 is adjusted and increased by squeegee 5. Squeegee 5 scrapes off powder 2 at a position higher than the gap between squeegee 5 and current collector 1 to adjust the weight per unit area and the thickness of powder layer 3.

Control unit 13 is a control mechanism (control device) for controlling at least one of the gap between squeegee 5 and current collector 1 and the vibration of squeegee 5. Control unit 13 adjusts, for example, the position of at least one of squeegee 5 and current collector 1 in order to control the gap between squeegee 5 and current collector 1. Control unit 13 adjusts, for example, at least one of the amplitude and the frequency of the vibration of squeegee 5 as control over the vibration of squeegee 5. When control unit 13 controls at least one of the gap between squeegee 5 and current collector 1 and the vibration of squeegee 5, squeegee 5 fills powder layer 3 with powder 2 at a filling rate equal to or higher than the tap density of powder 2. Accordingly, the amount of the voids in powder layer 3 are further reduced, and the variation in the weight per unit area of powder layer 3 is reduced. This is because bias of the voids in the powder layer 3 is the factor influencing the variation in the weight per unit area, so that the amount of the voids is reduced to reduce the bias of the voids.

In order to adjust the filling rate of powder 2 in powder layer 3, control unit 13 may control a supply amount of powder 2 by powder supply unit 11 and/or a relative movement speed of current collector 1 by drive unit 12.

### Other Embodiments

The powder layer composite and the like according to the present disclosure have been described above based on the embodiment, but the present disclosure is not limited to the above embodiment. The above embodiment is an example, within the scope of the claims of the present disclosure, any object having substantially the same structure as the technical idea and having the same effect and function is included in the technical scope of the present disclosure. As long as the gist of the present disclosure is not deviated, various modifications that can be conceived by those skilled in the art are applied to the embodiment, and other embodiments constructed by combining some components in the embodiment are also included in the scope of the present disclosure.

For example, in the above embodiment, an example in which the ions conducted in the positive electrode and the negative electrode are lithium ions has been described, but the present disclosure is not limited thereto. The ions conducted in the positive electrode and the negative electrode may be ions other than lithium ions, such as sodium ions, magnesium ions, potassium ions, calcium ions, or copper ions.

### INDUSTRIAL APPLICABILITY

The powder layer composite for an energy device according to the present disclosure is substantially free of a solvent, has a small variation in a weight per unit area, and includes a uniform powder layer, and therefore can be applied to various applications such as an electrode in a high-quality all-solid-state battery.

What is claimed is:

1. A powder layer composite for an energy device, the powder layer composite comprising:
a current collector; and
a powder layer formed on the current collector and having a film thickness of 50 μm or more, wherein
the powder layer contains a powder made of at least one type of particle material,
a concentration of a solvent contained in the powder layer is 50 ppm or less, and
a variation in a weight per unit area of the powder layer is 10% or less in an optional region with 30 mm×30 mm in the powder layer.

2. The powder layer composite for an energy device of claim 1, wherein
a filling rate of the powder in the powder layer is equal to or higher than a tap filling rate of the powder.

3. The powder layer composite for an energy device of claim 2, wherein
the at least one type of particle material contains a main powder that is a particle material having a largest volume ratio among the at least one type of particle material,
a particle size distribution of the main powder represented by (D90−D10)/D50 is larger than 75%, and
the filling rate of the powder in the powder layer is 1.1 times or more the tap filling rate of the powder.

4. The powder layer composite for an energy device of claim 1, wherein
a filling rate of the powder in the powder layer is 80% or more.

5. The powder layer composite for an energy device of claim 1, wherein
the current collector is a positive electrode current collector, and
the powder contains a positive electrode active material and a solid electrolyte having ion conductivity as the at least one type of particle material.

6. The powder layer composite for an energy device of claim 1, wherein
the current collector is a negative electrode current collector, and
the powder contains a negative electrode active material and a solid electrolyte having ion conductivity as the at least one type of particle material.

7. A method for manufacturing a powder layer composite for an energy device, the method comprising:
supplying a powder onto a surface of a current collector to form a powder layer containing the powder; and
adjusting a thickness of the powder layer and a filling rate of the powder in the powder layer by using the squeegee vibrated at a frequency of 2 kHz or more and 300 kHz or less, while relatively moving the current collector in a predetermined direction with respect to a squeegee disposed to form a gap with the current collector, wherein
in the adjusting of the thickness of the powder layer and the filling rate of the powder in the powder layer, the powder in the powder layer is filled such that the filling rate of the powder in the powder layer is equal to or higher than a tap filling rate of the powder.

8. The method for manufacturing a powder layer composite for an energy device of claim 7, wherein
the powder contains at least one type of particle material,
the at least one type of particle material contains a main powder that is a particle material having a largest volume ratio among the at least one type of particle material,
a particle size distribution of the main powder represented by (D90−D10)/D50 is larger than 75%, and
in the adjusting of the thickness of the powder layer and the filling rate of the powder in the powder layer, the powder in the powder layer is filled such that the filling rate of the powder in the powder layer is 1.1 times or more the tap filling rate of the powder.

9. The method for manufacturing a powder layer composite for an energy device of claim 7, wherein
the adjusting of the thickness of the powder layer and the filling rate of the powder in the powder layer includes ejecting a part of the powder in the powder layer to a position where a height from the current collector is higher than the gap.

10. The method for manufacturing a powder layer composite for an energy device of claim 9, wherein
the adjusting of the thickness of the powder layer and the filling rate of the powder in the powder layer includes scraping off the ejected part of the powder with the squeegee to adjust the thickness of the powder layer.

11. A powder coating apparatus for an energy device, the powder coating apparatus comprising:
a powder supply unit configured to supply a powder onto a surface of a current collector;
a squeegee disposed to form a gap with the current collector, and configured to be vibrated at a frequency of 2 kHz or more and 300 kHz or less, and to adjust a weight per unit area and a filling rate of the powder supplied onto the surface of the current collector by the powder supply unit;
a drive unit configured to relatively move the current collector in a predetermined direction with respect to the squeegee; and
a control unit configured to control at least one of the gap and vibration of the squeegee.
